(19) United States
(12) Patent Application Publication
(10) Pub. No.: US 2003/0031001 A1
(43) Pub. Date: Feb. 13, 2003

(54) Flat panel display and printed circuit board used therein

(75) Inventor: Chun Yen Chu, Tainan Science-Based Industrial Park (TW)

Correspondence Address: LOWE HAUPTMAN GILMAN & BERNER, LLP, Suite 310, 1700 Diagonal Road, Alexandria, VA, 22314, US

(73) Assignee: CHI MEI OPTOELECTRONICS CORP.

(21) Appl. No.: 10/118,004

(22) Filed: Apr. 9, 2002

(30) Foreign Application Priority Data
Aug. 13, 2001 (TW) 90119971

(51) Int. Cl. G02F 1/1345

(52) U.S. Cl. 361/784; 174/256; 174/261; 349/149; 349/150; 349/151

(57) ABSTRACT

A flat panel display comprising a display panel, and a first and second printed circuit boards connected to the display panel. The first printed circuit board has a connector. The second printed circuit board comprises a core layer having a main body and a branch extending from the main body. The branch has a terminal portion. A plurality of electrically conductive leads are formed on the surface of the main body and extends to the terminal portion. The terminal portion of the branch including the conductive leads formed thereon is directly inserted into the connector of the first printed circuit board.

### BACKGROUND OF THE INVENTION

1. Field of the Invention

The present invention relates to a substrate for a flat panel display, and more particularly, to a printed circuit board for a liquid crystal display.

2. Description of the Related Art

Electronic assemblies (e.g., flat panel displays) having more than one printed circuit board need to have a means of interconnecting the circuit boards to each other. In some instances, flexible printed circuits (FPC) are used to achieve these interconnections, each interconnection requiring a connector on one or both ends of the FPC. Connectors are used to permit the functional units, such as cards or circuit boards, to be individually inserted and removed for reasons of testability, rework, and repair.

A conventional liquid crystal display module 100 is shown in FIG. 1 and FIG. 2. This liquid crystal display module 100 is mainly composed of a liquid crystal display panel 110, a plurality of tape carrier packages (TCPs) 120, two printed circuit boards 130, 140 and a backlight unit (not shown). The liquid crystal display panel 110 is mainly composed of an upper glass substrate 112, a lower glass substrate 114, and a liquid crystal layer (not shown) interposed therebetween. Polarizing films (not shown) are attached onto the outside of each substrate 112, 114. The printed circuit board 130 is provided with a flexible printed circuit (FPC) 150. The printed circuit board 140 is provided with a connector 160.

Referring to FIG. 2, the tape carrier packages (TCPS) 120 are bent along the contour of the liquid crystal display module 100 such that the printed circuit boards 130, 140 are bent into the backside of the liquid cystal display module 100. Then, the FPC 150 is inserted into the connector 160 such that the printed circuit boards 130, 140 are connected to each other through the FPC 150.

In the prior art described above, at least a FPC is required to interconnect the two printed circuit boards. This FPC adds additional material cost to the overall manufacturing cost of the liquid crystal display module. Moreover, the FPC is soldered to the printed circuit board via surface mount technology (SMT) and tested after soldering. Such additional soldering process and testing complicate the whole process and prolong the cycle time for manufacturing the liquid crystal display module thereby increasing the overall production cost.

### SUMMARY OF THE INVENTION

It is an object of the present invention to provide a printed circuit board which overcomes, or at least reduces the above-mentioned problems of the prior art.

It is another object of the present invention to provide a printed circuit board which completely eliminates the need for flexible printed circuit (FPC), and still provides a physical and electrical interconnection between one or more printed circuit boards.

To achieve the above listed and other objects, the present invention provides a printed circuit board mainly comprising a core layer having a main body and a branch extending from the main body. The branch has a terminal portion. A first conductive circuitry is formed on the upper surface of the main body of the core layer. A second conductive circuitry is formed on the lower surface of the main body of the core layer and electrically connected to the first conductive circuitry. The upper surface of the branch of the core layer has a plurality of electrically conductive leads formed thereon. Each of the conductive leads has a first end portion electrically connected to the second conductive circuitry and a second end portion on the terminal portion of the branch adapted for electrically connecting to a connector such as a FPC connector. The first conductive circuitry and the upper surface of the core layer are covered with a first solder mask wherein the surface of the branch of the core layer is exposed from the first solder mask. The lower surface of the core layer, the conductive leads and the second conductive circuitry are covered with a second solder mask except for the terminal portion of the branch and the second end portions of the conductive leads.

Preferably, the first or the second conductive circuitry has at least a portion adapted for connecting to a tape carrier package (TCP). Furthermore, the first or the second conductive circuitry has at least a portion adapted for connecting to a drive integrated circuit (IC) such as a gate drive IC.

The printed circuit board of the present invention is characterized by having an integrally formed branch. The terminal portion of the branch, including the second end portions of the conductive leads formed thereon, is designed to be directly inserted into a connector disposed on another printed circuit board. This completely eliminates the need for flexible printed circuit (FPC), and still provides a physical and electrical interconnection between the two printed circuit boards.

The present invention further provides a flat panel display (e.g., a liquid crystal display module) mainly comprising a display panel (e.g., a liquid crystal display panel), a first printed circuit board having a branch, a second printed circuit board having a connector and a plurality of tape carrier packages connecting the two printed circuit boards to the liquid crystal display panel. Specifically, each of the tape carrier packages comprises a data drive IC or a gate drive IC and the first printed circuit board has a plurality of conductive leads formed on a terminal portion of the branch. It is noted that the terminal portion of the branch is directly inserted into the connector of the second printed circuit board so as to provide a physical and electrical interconnection between the two printed circuit boards thereby eliminating the need for flexible printed circuit (FPC).

### BRIEF DESCRIPTION OF THE DRAWINGS

Other objects, advantages, and novel features of the invention will become more apparent from the following detailed description when taken in conjunction with the accompanying drawings:

FIG. 1 is a top plan view of a conventional liquid crystal display module illustrating a first printed circuit board provided with a flexible printed circuit and a second printed circuit board having a connector;

FIG. 2 is a bottom plan view of the liquid crystal display module of FIG. 1 illustrating the connection of the first printed circuit board to the second printed circuit board by inserting the flexible printed circuit into the connector;

FIG. 3 is a top plan view of a liquid crystal display module according to a preferred embodiment of the present invention illustrating a first printed circuit board having an integrally formed branch and a second printed circuit board having a connector;

FIG. 4 is a bottom plan view of the liquid crystal display module of FIG. 3 illustrating the connection of the first printed circuit board to the second printed circuit board by inserting the branch into the connector;

FIG. 5 is a top plan view of a printed circuit board having an integrally formed branch according to a preferred embodiment of the present invention; and

FIG. 6 is a cross sectional view taken from the line 6-6 of FIG. 5.

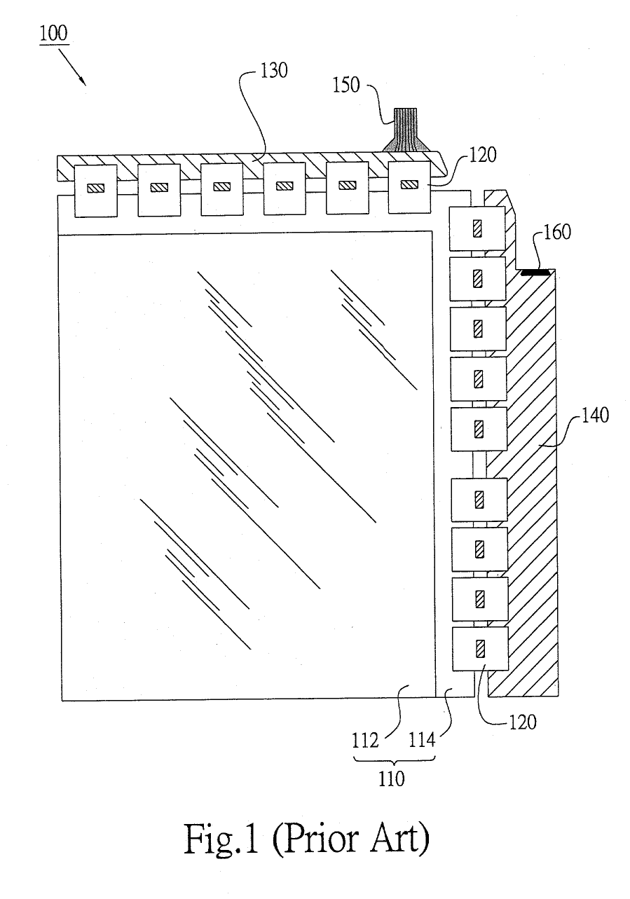

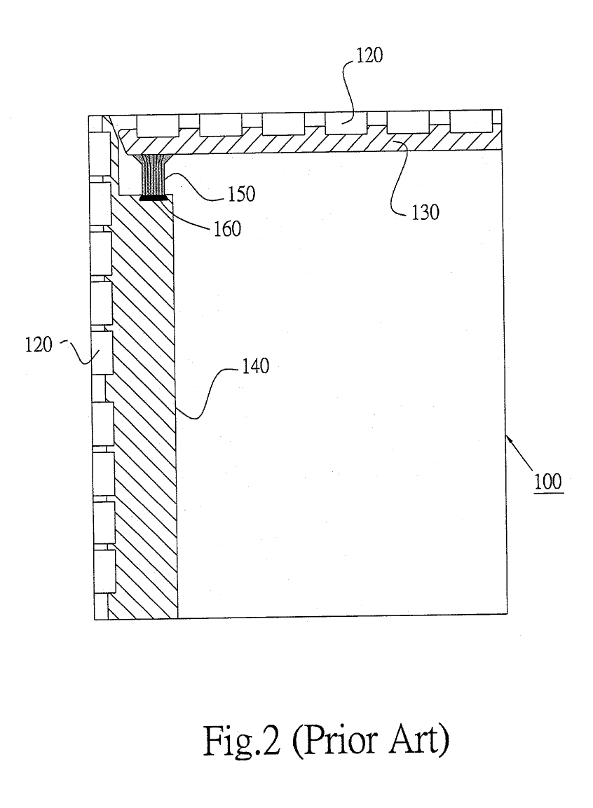

### DETAILED DESCRIPTION OF THE PREFERRED EMBODIMENT

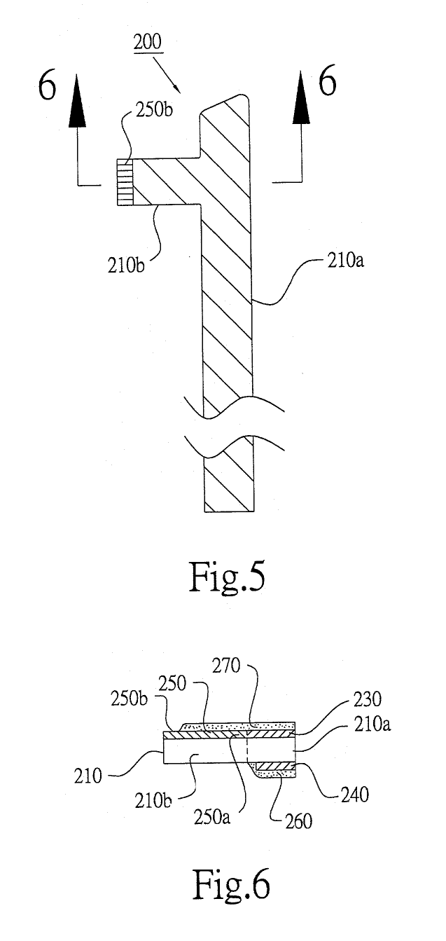

FIG. 5 and FIG. 6 show a printed circuit board 200 according to a preferred embodiment of the present invention. The printed circuit board 200 mainly comprises a core layer 210 having a main body 210a and a branch 210b extending from the main body. The upper surface of the main body 210a of the core layer 210 is provided with a conductive circuitry 230 and the lower surface of the main body 210a of the core layer 210 is provided with a conductive circuitry 240. The conductive circuitry 230 may be electrically connected to the conductive circuitry 240 through a plurality of plated through holes (not shown). The upper surface of the branch 210b of the core layer 210 has a plurality of electrically conductive leads 250 formed thereon. Each of the conductive leads 250 has a first end portion 250a electrically connected to the conductive circuitry 230 and a second end portion 250b on the terminal portion of the branch 210b adapted for electrically connecting to a connector. The conductive leads 250 may extend to the upper surface of the main body 210a and form a portion of the conductive circuitry 230. The lower surface of the main body 210a of the core layer 210 including the conductive circuitry 240 are covered with a solder mask 260 wherein the surface of the branch 210b of the core layer 210 is exposed from the solder mask 260. The lower surface of the main body 210a of the core layer 210 including the conductive circuitry 240 is covered with a solder mask 260 wherein the surface of the branch 210b of the core layer 210 is exposed from the solder mask 260. The upper surface of the core layer 210 including the conductive leads 250 and the conductive circuitry 230 is covered with a solder mask 270 except for the terminal portion of the branch 210b and the second end portions 250b of the conductive leads 250.

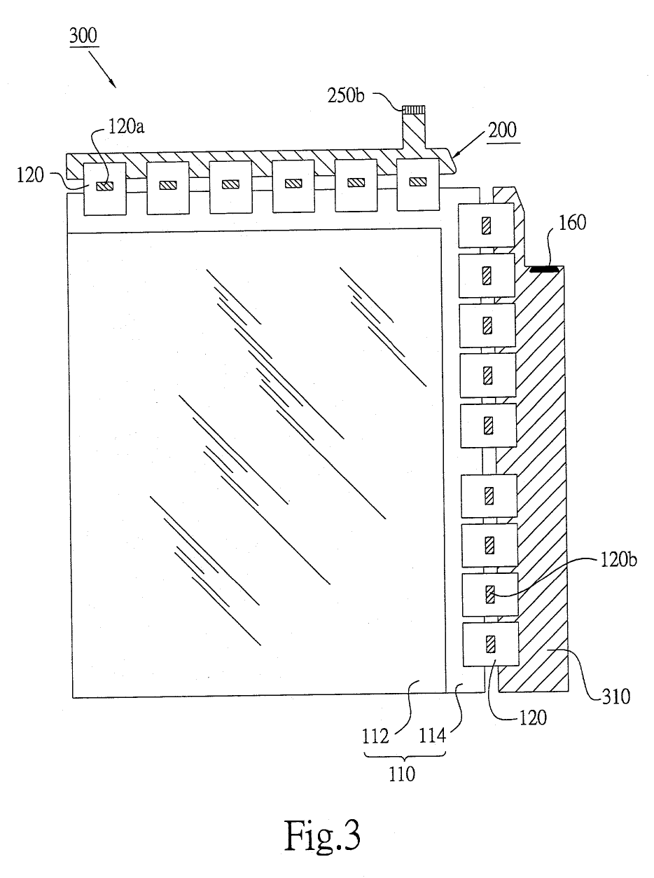

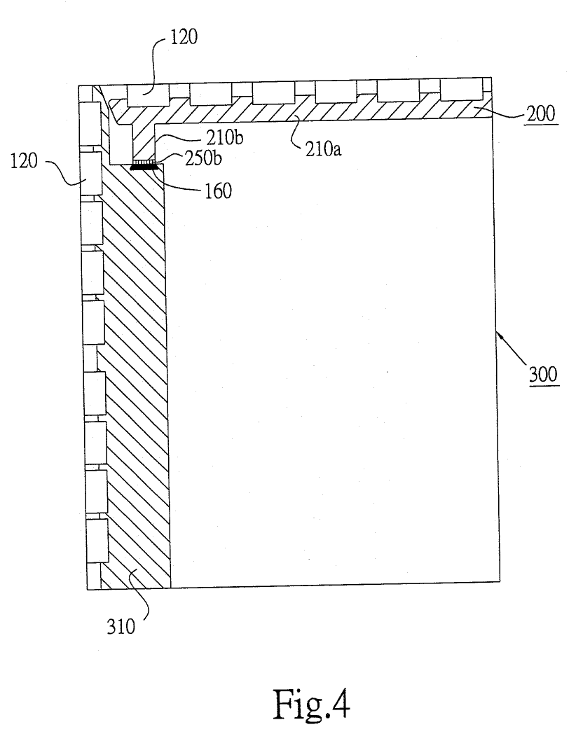

FIG. 3 and FIG. 4 show a liquid crystal display module 300 utilizing the printed circuit board 200 of the present invention. The printed circuit board 200 is connected to a liquid crystal display panel 110 through a plurality of tape carrier packages 120. Therefore, the conductive circuitry 230 (not shown in FIG. 3 and FIG. 4) on the printed circuit board 200 has at least a portion adapted for connecting to a tape carrier package (TCP). The liquid crystal display panel 110 is mainly composed of an upper glass substrate 112, a lower glass substrate 114, and a liquid crystal layer (not shown) interposed therebetween. It could be understood that the upper glass substrate 112 may be a color filter (CF) substrate, and the lower glass substrate 114 may be a thin film transistor (TFT) substrate. Typically, the tape carrier package 120 comprises a drive integrated circuit (IC) packaged by the tape automated bonding (TAB) method. The drive IC may be a gate drive IC or a data drive IC. The printed circuit board 200 may be referred to as a gate board because it is typically adapted for electrically connecting to a gate drive IC. Therefore, the conductive circuitry 230 (not shown in FIG. 3 and FIG. 4) on the printed circuit board 200 has at least a portion adapted for electrically connecting to gate drive ICs. Another printed circuit board 310 may be referred to as a source board because it is typically adapted for electrically connecting to data drive ICs. The printed circuit board 310 is also connected to the liquid crystal display panel 110 through a plurality of tape carrier packages 120. The printed circuit board 310 has a connector such as a FPC connector 160. The connector 160 is typically a plastic component with numerous electrical contacts which are soldered directly to the printed circuit board 310. In the present invention, the connector is used to provide a separable interface between the two printed circuit boards.

Referring to FIG. 4, the tape carrier packages (TCPs) 120 are bent along the contour of the liquid crystal display module 300 such that the printed circuit boards 200, 310 are bent into the backside of the liquid crystal display module 300. Then, the terminal portion of the branch 210b of the printed circuit board 200, including the second end portions 250b of the conductive leads formed thereon, is directly inserted into the FPC connector 160. This completely eliminates the need for flexible printed circuit (FPC), and still provides a physical and electrical interconnection between the two printed circuit boards 200, 310.

Typically, the FPC connector 160 has an applicable thickness specification of 0.15±0.03 mm. Therefore, the overall thickness of the branch 210b of the printed circuit board 200 and the second end portions 250b of the conductive leads (see FIG. 6) should be kept between 0.12 mm and 0.18 mm such that meets the applicable thickness specification of the connector. The printed circuit board 200 of the present invention is preferably formed from a core layer with a thickness of 4 mils (about 0.1 mm) and the conductive leads are preferably formed from a copper foil with a thickness of 0.5 ounce per square feet (about 0.018 mm).

The printed circuit board of the present invention is characterized by having an integrally formed branch. The terminal portion of the branch, including the second end portions of the conductive leads formed thereon, is designed to be directly inserted into a connector disposed on another printed circuit board. This completely eliminates the need for flexible printed circuit (FPC), and still provides a physical and electrical interconnection between the two printed circuit boards.

Therefore, if either the gate board or the source board of a LCD module adopts the design of the present invention, the gate board can be physically and electrically connected to the source board without the use of flexible printed circuit (FPC). The innovative design of the present invention not only saves the material cost of the FPC but also skips conventional SMT soldering and testing steps thereby significantly reducing the cycle time for manufacturing the liquid crystal display module and increasing the yield rate. Although the present invention is discussed in detail with respect to a printed circuit board for a liquid crystal display module, the present invention is applicable to a wide variety of flat panel displays including at least two circuit boards.

Although the invention has been explained in relation to its preferred embodiment, it is to be understood that many other possible modifications and variations can be made without departing from the spirit and scope of the invention as hereinafter claimed. For example, although only the conventional gate board is replaced by the PCB with a branch of the present invention as preferred embodiments, it is still within the spirit and scope of the invention as hereinafter claimed that the PCB of the present invention may also be designed to substitute for the conventional source board.

What is claimed is:

1. A printed circuit board comprising:
a core layer having a main body and a branch extending from the main body, the branch having a terminal portion adapted to be inserted into a connector;
an electrically conductive circuitry formed on at least a surface of the main body of the core layer; and
a plurality of electrically conductive leads formed on at least a surface of the branch of the core layer, each of the conductive leads having a first end portion electrically connected to the conductive circuitry and a second end portion on the terminal portion of the branch wherein the second end portions of the conductive leads are electrically connected to the connector when the terminal portion of the branch is inserted into a connector.

2. The printed circuit board as claimed in claim 1, wherein the conductive circuitry has at least a portion adapted for connecting to a tape carrier package (TCP).

3. The printed circuit board as claimed in claim 1, wherein the conductive circuitry has at least a portion adapted for connecting to a drive integrated circuit (IC).

4. The printed circuit board as claimed in claim 1, wherein the conductive circuitry has at least a portion adapted for connecting to a gate drive IC.

5. The printed circuit board as claimed in claim 1, wherein the second end portions of the conductive leads are adapted for electrically connecting to a flexible printed circuit (FPC) connector.

6. The printed circuit board as claimed in claim 1, wherein the overall thickness of the core layer and the conductive lead meets the applicable thickness specification of the connector.

7. A flat panel display comprising:
a display panel;
a first printed circuit board connected to the display panel, the first printed circuit board having a connector; and
a second printed circuit board connected to the display panel, the second printed circuit board comprising a core layer having a main body and a branch extending from the main body, the branch having a terminal portion adapted to be inserted into a connector; an electrically conductive circuitry formed on at least a surface of the main body of the core layer; and
a plurality of electrically conductive leads formed on the branch of the core layer, wherein each of the conductive leads has a first end portion electrically connected to the conductive circuitry and a second end portion on the terminal portion of the branch,
wherein the terminal portion of the branch and the second end portions of the conductive leads thereon are inserted into the connector of the first printed circuit board.

8. The flat panel display as claimed in claim 7, wherein the connector is a flexible printed circuit (FPC) connector.

9. The flat panel display as claimed in claim 7, wherein the first and second printed circuit boards are connected to the display panel through tape carrier packages.

10. The flat panel display as claimed in claim 9, wherein each of the tape carrier packages connected between the first printed circuit board and the display panel comprises a data drive IC, and each of the tape carrier packages connected between the second printed circuit board and the display panel comprises a gate drive IC.

11. The flat panel display as claimed in claim 9, wherein each of the tape carrier packages connected between the first printed circuit board and the display panel comprises a gate drive IC, and each of the tape carrier packages connected between the second printed circuit board and the display panel comprises a data drive IC.

12. The flat panel display as claimed in claim 7, wherein the conductive circuitry on the second printed circuit board comprises a first conductive circuitry formed on a first surface of the main body of the core layer and a second conductive circuitry formed on a second surface of the main body of the core layer, wherein the second conductive circuitry is electrically connected to the first conductive circuitry, and the second printed circuit board further comprises a first solder mask formed over the first conductive circuitry such that the surface of the branch of the core layer is exposed from the first solder mask, and a second solder mask formed over the conductive leads and the second conductive circuitry such that the terminal portion of the branch and the second end portions of the conductive leads are exposed from the second solder mask.

13. The flat panel display as claimed in claim 7, wherein the display panel is a liquid crystal display panel.

14. A printed circuit board comprising:
a core layer having opposing first and second surfaces, a main body and a branch extending from the main body, the branch having a terminal portion;
a first conductive circuitry formed on a first surface of the main body of the core layer;
a second conductive circuitry formed on a second surface of the main body of the core layer and electrically connected to the first conductive circuitry;
a plurality of electrically conductive leads formed on the branch of the core layer, each of the conductive leads having a first end portion electrically connected to the second conductive circuitry and a second end portion on the terminal portion of the branch adapted for electrically connecting to a connector;
a first solder mask formed over the first conductive circuitry and the first surface of the core layer such that the surface of the branch of the core layer is exposed from the first solder mask; and
a second solder mask formed over the conductive leads, the second conductive circuitry and the second surface of the core layer such that the terminal portion of the branch and the second end portions of the conductive leads are exposed from the second solder mask.

15. The printed circuit board as claimed in claim 14, wherein the first or the second conductive circuitry has at least a portion adapted for connecting to a tape carrier package (TCP).

16. The printed circuit board as claimed in claim 14, wherein the first or the second conductive circuitry has at least a portion adapted for connecting to a drive integrated circuit (IC).

17. The printed circuit board as claimed in claim 14, wherein the first or the second conductive circuitry has at least a portion adapted for connecting to a gate drive IC.

18. The printed circuit board as claimed in claim 14, wherein the second end portions of the conductive leads are adapted for electrically connecting to a flexible printed circuit (FPC) connector.

19. The printed circuit board as claimed in claim 14, wherein the overall thickness of the core layer and the conductive lead meets the applicable thickness specification of the connector.

20. The printed circuit board as claimed in claim 14, wherein the conductive leads on the branch of the core layer are extended from the second conductive circuitry.
